(19) United States
(12) Patent Application Publication
(10) Pub. No.: US 2015/0370582 A1
(43) Pub. Date: Dec. 24, 2015

(54) AT LEAST ONE USER SPACE RESIDENT INTERFACE BETWEEN AT LEAST ONE USER SPACE RESIDENT VIRTUAL APPLIANCE AND AT LEAST ONE VIRTUAL DATA PLANE

(71) Applicants: Ray Kinsella, Shannon (IE); Thomas Long, Shannon (IE); Joshua Adam Triplett, Hillsboro, OR (US)

(72) Inventors: Ray Kinsella, Shannon (IE); Thomas Long, Shannon (IE); Joshua Adam Triplett, Hillsboro, OR (US)

(21) Appl. No.: 14/309,749

(22) Filed: Jun. 19, 2014

(51) Int. Cl. G06F 9/455; G06F 9/54

(52) U.S. Cl. CPC G06F 9/455; G06F 9/545; G06F 9/45533

(57) ABSTRACT

In an embodiment, circuitry may be provided that may execute at least one interface process in a user space of a host. The host, in operation, also may have a kernel space. The at least one process may provide at least one interface, at least in part, between at least one virtual appliance and at least one virtual data plane. The at least one virtual data plane may facilitate communication between at least one physical device and the at least one virtual appliance via the at least one interface. The at least one physical device may appear to the at least one virtual appliance, when the at least one virtual appliance communicates with the at least one physical device via the at least one interface, as at least one local device. The at least one virtual appliance and the at least one interface may be resident in the user space.

### TECHNICAL FIELD

This disclosure relates to at least one user space resident interface process that, when executed, provides at least one user space resident interface between at least one user space resident virtual appliance and at least one virtual data plane.

### BACKGROUND

In one conventional network virtualization arrangement, a virtual appliance resides in a host's user space. The host also includes an operating system privileged kernel space. Virtual fabric, virtual switch, and network interface controller processes reside in the kernel space and are part of the operating system kernel. The network interface controller process is capable of communicating with and controlling operations performed by a physical network interface controller. In operation, the virtual appliance communicates with an external network by exchanging commands and data with the controller, via these virtual fabric, virtual switch, and network interface controller processes resident in the host's kernel space.

In this conventional arrangement, these kernel space resident processes are mutually distinct software processes. As a result, each succeeding stage in the communication process (e.g., in which commands and data are passed from the virtual appliance first to the virtual fabric process, then to the virtual switch process, then subsequently to the network interface controller process, and thence to the physical network device, or vice versa), involves a separate copying and buffering of the commands and data. As can be readily appreciated, this introduces significant processing overhead and latency.

Also, since the virtual appliance resides in the user space, but the virtual fabric, virtual switch, and network interface controller processes reside in and are part of the operating system kernel, the invocation of these operating system processes by the virtual appliance, as well as, the passing of commands and data between the user space and the kernel space, involve context switch and other operating system related processing overhead and latency. Additionally, since the virtual fabric, virtual switch, network interface controller processes are part of the operating system kernel, any modification and/or extension of these processes (e.g., to offer other and/or additional functionality) may implicate the operating system's producer's proprietary (e.g., intellectual property) rights.

### BRIEF DESCRIPTION OF THE SEVERAL VIEWS OF THE DRAWINGS

Features and advantages of embodiments will become apparent as the following Description of Embodiments proceeds, and upon reference to the Drawings, wherein like numerals depict like parts, and in which:

FIG. 1 illustrates a network system embodiment.

FIG. 2 illustrates features in an embodiment.

FIG. 3 illustrates features in an embodiment.

FIG. 4 illustrates features in an embodiment.

Although the following Description of Embodiments will proceed with reference being made to illustrative embodiments, many alternatives, modifications, and variations thereof will be apparent to those skilled in the art. Accordingly, it is intended that the claimed subject matter be viewed broadly.

### DESCRIPTION OF EMBODIMENTS

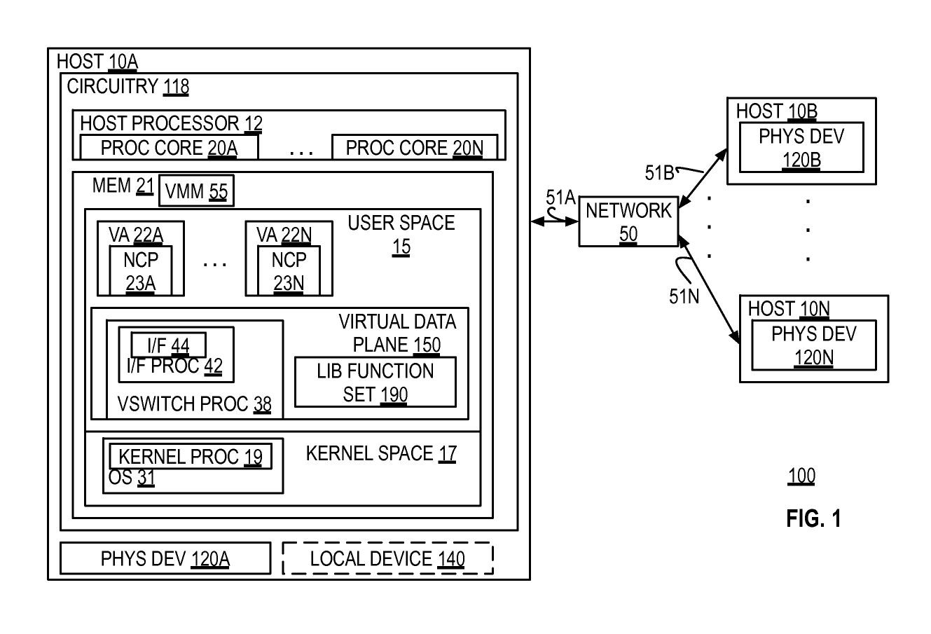

FIG. 1 illustrates a network system embodiment 100. In this embodiment, system 100 may be advantageously employed for use in connection with and/or in accordance with, and/or to implement, at least in part, one or more virtualization-related usage models. System 100 may comprise one or more (and in this embodiment, a plurality of) hosts 10A, 10B, . . . 10N. Hosts 10A, 10B, . . . 10N may be communicatively coupled, via one or more respective network communication links 51A, 51B, . . . 51N, to one or more networks 50. By being so communicatively coupled to one or more networks 50, hosts 10A, 10B, . . . 10N may be capable of exchanging commands and/or data between or among themselves via one or more networks 50.

In this embodiment, each of the hosts 10A, 10B, . . . 10N may be have a similar or identical construction and/or operation. Alternatively, without departing from this embodiment, the respective constructions and/or operations of hosts 10A, 10B, . . . 10N may differ, at least in part. One or more hosts 10A may comprise, at least in part, circuitry 118 and/or one or more physical devices 120A. Analogously, each of the hosts 10B . . . 10N may comprise its own respective circuitry (not shown) and/or one or more respective physical devices 120B . . . 120N.

Circuitry 118 may comprise one or more host processors 12, and/or one or more computer-readable and/or writable memories 21. One or more host processors 12 may comprise one or more (and in this embodiment, a plurality of) processor cores 20A . . . 20N. Additionally, although not shown, each of the hosts 10A . . . 10N may comprise, at least in part, one or more respective graphical user interfaces that may permit one or more (not shown) human users/operators to be able to input commands to, and to receive data from, the hosts 10A . . . 10N, system 100, and/or components thereof, in order to permit the one or more users/operators to be able to control and/or monitor the operation of the hosts 10A . . . 10N, system 100, and/or components thereof.

In this embodiment, the terms host computer, host, platform, server, client, network node, and node may be used interchangeably, and may mean, for example, without limitation, one or more virtual, physical, and/or logical entities, such as, one or more end stations, network (and/or other types of) devices, mobile internet devices, smart phones, media devices, input/output (I/O) devices, tablet computers, appliances, intermediate stations, network and/or other interfaces, clients, servers, fabric (and/or other types of) switches, and/or portions and/or components thereof. In this embodiment, a network, network communication link, communication link, and/or link may be or comprise any entity, instrumentality, modality, and/or portion thereof that permits, facilitates, and/or allows, at least in part, two or more entities to be communicatively coupled together. In this embodiment, a switch may be or comprise, at least in part, any entity that is capable of forwarding, at least in part, one or more packets. In this embodiment, forwarding of one or more packets may be and/or comprise, at least in part, issuing, at least in part, the one or more packets toward one or more (intermediate and/or ultimate) destinations (e.g., via and/or using one or more hops).

In this embodiment, a first entity may be “communicatively coupled” to a second entity if the first entity is capable of transmitting to and/or receiving from the second entity one or more commands and/or data. In this embodiment, data and information may be used interchangeably, and may be or comprise one or more commands (for example one or more program instructions), and/or one or more such commands may be or comprise data and/or information. Also in this embodiment, an instruction and/or programming may include data and/or one or more commands. In this embodiment, a packet may be or comprise one or more symbols and/or values. In this embodiment, traffic and/or network traffic may be or comprise one or more packets.

In this embodiment, “circuitry” may comprise, for example, singly or in any combination, analog circuitry, digital circuitry, hardwired circuitry, programmable circuitry, processor circuitry, co-processor circuitry, state machine circuitry, and/or memory. In this embodiment, a processor, host processor, co-processor, central processing unit (CPU), processor core, core, and/or controller each may comprise respective circuitry capable of (1) performing, at least in part, one or more arithmetic and/or logical operations, and/or (2) executing, at least in part, one or more instructions. In this embodiment, memory, cache, and cache memory each may comprise one or more of the following types of memories: semiconductor firmware memory, programmable memory, non-volatile memory, read only memory, electrically programmable memory, random access memory, flash memory, magnetic disk memory, optical disk memory, and/or other computer-readable and/or writable memory.

In this embodiment, instantiation and/or allocation of an entity may be or comprise, at least in part, establishment and/or creation, at least in part, of the entity. In this embodiment, a device may be or comprise one or more physical, logical, and/or virtual entities that may comprise, at least in part, circuitry.

In this embodiment, a portion or subset of an entity may comprise all or less than all of the entity. In this embodiment, a set may comprise one or more elements. Also, in this embodiment, a process, thread, daemon, program, driver, operating system, application, kernel, virtual machine, virtual appliance, and/or virtual machine monitor each may (1) comprise, at least in part, and/or (2) result, at least in part, in and/or from, execution of one or more operations and/or program instructions. In this embodiment, an interface, such as, for example, an application programming interface (referred to in the single or plural as “API” hereinafter) may be or comprise one or more physical, logical, and/or virtual interfaces via which (1) a first entity provide data and/or one or more signals, commands, instructions to a second entity that may permit and/or facilitate, at least in part, control, monitoring, and/or interaction, at least in part, with the second entity, and/or (2) the second entity may provide other data and/or one or more other signals that may permit and/or facilitate, at least in part, such control, monitoring, and/or interaction, at least in part. In this embodiment, an interface be, comprise, and/or result from, at least in part, one or more processes executed by circuitry.

For example, in this embodiment, memory 21 may comprise one or more instructions that when executed by, for example, circuitry 118, one or more host processors 12, and/or one or more of the processor cores 20A . . . 20N may result, at least in part, in one or more virtual machine monitors (VMM) 55, virtual appliances (VA) 22A . . . 22N, virtual data planes 150, and/or operating systems (OS) 31 (and/or one or more components thereof), (1) being executed, at least in part, by circuitry 118, one or more host processors 12 and/or processor cores 20A . . . 20N, and/or (2) becoming resident, at least in part, in memory 21. The execution and/or operation of the one or more respective one or more VMM 55, VA 22A . . . 22N, virtual data planes 150, and/or OS 31 (and/or one or more components thereof) may result, at least in part, in performance of the operations that are described herein as being performed by one or more hosts 10A and/or components thereof.

For example, in operation, the one or more not shown users may input one or more commands that may result, at least in part, in one or more VMM 55, OS 31, VA 22A . . . 22N and/or virtual data planes 150 being executed, and/or becoming resident in one or more memories 21. More specifically, in operation, one or more OS 31 may be resident in one or more kernel spaces 17 in one or more memories 17. Also, in operation, VA 22A . . . 22N and/or virtual data planes 150 may be resident in one or more user spaces 15.

In this embodiment, VA 22A . . . 22N may comprise, at least in part, one or more respective network communication application processes 23A . . . 23N. Also, in this embodiment, one or more virtual data planes 150 may comprise, at least in part, one or more virtual switch processes 38 and/or one or more sets of library functions 190. One or more virtual switch processes 38 may comprise, at least in part, one or more virtual interface processes 42. One or more interface processes 42 may comprise and/or provide, at least in part, one or more virtual interfaces 44.

In this embodiment, a virtual data plane may be or comprise, at least in part, at least one process that may be capable of emulating, at least in part, one or more operations performable by one or more virtual and/or physical data plane. In this embodiment, a data plane may be or comprise, at least in part, at least one path via which one or more packets may be forwarded.

Although not shown in the Figures, one or more VMM 55 may be comprised, at least in part, in one or more kernel spaces 17, operating systems 31, and/or kernel processes 19. Additionally or alternatively, without departing from this embodiment, one or more operating systems 31 and/or kernel processes 19 may be comprised, at least in part, in one or more VMM 55. Many alternatives are possible without departing from this embodiment.

In this embodiment, a kernel or kernel process may be or comprise, at least in part, at least one subset of the most privileged portion of at least one operating system. For example, in this embodiment, one or more kernel processes 19 may reside, at least in part, within privilege ring 0 of one or more operating systems 31. In this embodiment, one or more host processors 12, operating systems 31, and/or kernel processes 19 may implement security and/or privilege techniques that may be intended to prevent and/or thwart access to and/or use of one or more kernel processes 19 by unauthorized entities. In this embodiment, a first entity may be said to be unauthorized to perform an action in connection with a second entity, if the first entity is not currently granted permission (e.g., by an owner and/or administrator of the second entity) to perform the action. In this embodiment, a kernel space may be or comprise, at least in part, one or more portions of one or more memories in which one or more kernel processes may reside and/or be executed, at least in part.

Also in this embodiment, an operating system or operating system process may be or comprise, at least in part, one or more processes (1) that may control, manage, and/or monitor one or more virtual and/or physical hardware and/or firmware resources, and/or (2) via which one or more user and/or application processes may be permitted to access and/or utilize, at least in part, such resources. In this embodiment, a user space may be or comprise, at least in part, one or more portions of one or more memories in which one or more user, application, and/or virtual appliance processes may reside and/or be executed, at least in part. In this embodiment, a virtual appliance may be or comprise, at least in part, at least one subset of at least one virtual machine (and/or virtual machine image) that may execute, at least in part, at least one application and/or application process. In this embodiment, a virtual machine may be or comprise, at least in part, at least one process that may be capable of (1) emulating, at least in part, one or more virtual and/or physical devices, operations, and/or functions of one or more virtual and/or physical host hardware and/or firmware resources, and/or (2) presenting and/or exposing, at least in part, one or more such emulated devices, operations, and/or functions to one or more portions of one or more operating systems.

In this embodiment, in operation, the one or more interface processes 42 that may be executed, at least in part, by circuitry 118 may provide one or more interfaces 44, at least in part, between one or more VA (e.g., 22A) and/or one or more virtual data planes 150. One or more virtual data planes 150 may facilitate, at least in part, communication between one or more of the physical devices (e.g., 120A . . . 120N) and/or one or more VA 22A via one or more interfaces 44. When the one or more VA 22A communicates with these one or more of the physical devices 120A . . . 120N via the one or more interfaces 44, the one or more of the physical devices 120A . . . 120N may appear, at least in part, as one or more local devices 140 (e.g., as being local to the one or more VA 22A). In this embodiment, a device may be considered to be local to an entity, if the device resides at least in part in the entity.

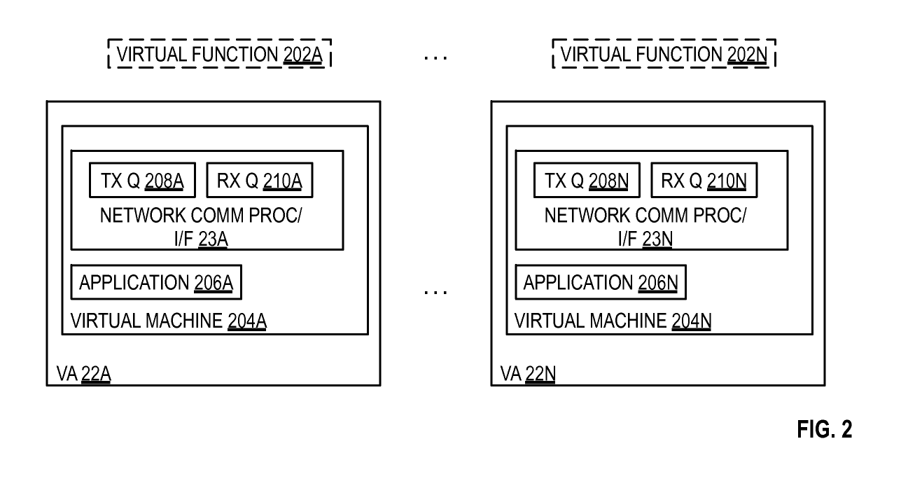

For example, with reference to FIG. 2, each of the VA 22A . . . 22N may be implemented, at least in part, by one or more respective virtual machines 204A . . . 204N that may execute and/or comprise one or more respective applications 206A . . . 206N and/or one or more respective network communication processes 23A . . . 23N. The execution of these applications 206A . . . 206N and/or processes 23A . . . 23N may result, at least in part, in the virtual machines 204A . . . 204N and/or VA 22A . . . 22N providing, at least in part, one or more respective virtual functions 202A . . . 202N. These virtual functions 202A may correspond to, be associated with, implement, and/or provide, at least in part, network-related (and/or other) services. Such services may comprise, for example, firewall, security, virus/malware detection, deep packet inspection, etc. For example, in order to implement such services, the applications 206A . . . 206N may provide, at least in part, the specific processing and/or computations involved in implementing such respective services, while physical devices 120A . . . 120N may each be or comprise one or more respective physical network I/O devices (e.g., one or more network interface controllers and/or related circuitry for communicating with one or more networks 50) whose network-related operations may be controlled and/or monitored, at least in part, by the applications 206A . . . 206N in such a way as to implement such services. In order to facilitate such control, monitoring, and/or communication, network communication processes 23A . . . 23N may (1) operate, at least in part, as respective network communication interfaces between the applications 206A . . . 206N and/or one or more interfaces 44, and/or (2) establish and/or maintain in virtual machines 204A . . . 204N respective sets of network operation/communication-related queues and/or associated data buffers. For example, one or more processes 23A may comprise, establish, and/or maintain one or more transmit queues 208A and/or one or more receive queues 210A that may be used by one or more applications 206A, virtual machines 204A, and/or VA 22A to monitor, control, carry out such network operations/communication operations and/or services. Analogously, one or more processes 23N may comprise, establish, and/or maintain one or more transmit queues 208N and/or one or more receive queues 210N that may be used by one or more applications 206N, virtual machines 204N, and/or VA 22N to monitor, control, carry out such network operations/communication operations and/or services. Although not shown in the Figures, processes 23A . . . 23N also may comprise, establish, and/or maintain respective network data buffers to be used to buffer packets and/or other data that are to be transmitted and/or have been received in connection with such network operations/communication operations and/or services. Depending upon the particular commands and/or data written to and/or read from such queues by applications 206A . . . 206N via processes 23A . . . 23N, applications 206A . . . 206N may monitor and/or control the operations of the physical network I/O devices 120A . . . 120N in such a way as to permit the applications 206A . . . 206N, virtual machines 204A . . . 204N, and/or VA 22A . . . 22N to implement and/or provide, at least in part, these respective virtual functions 202A . . . 202N and/or their corresponding services.

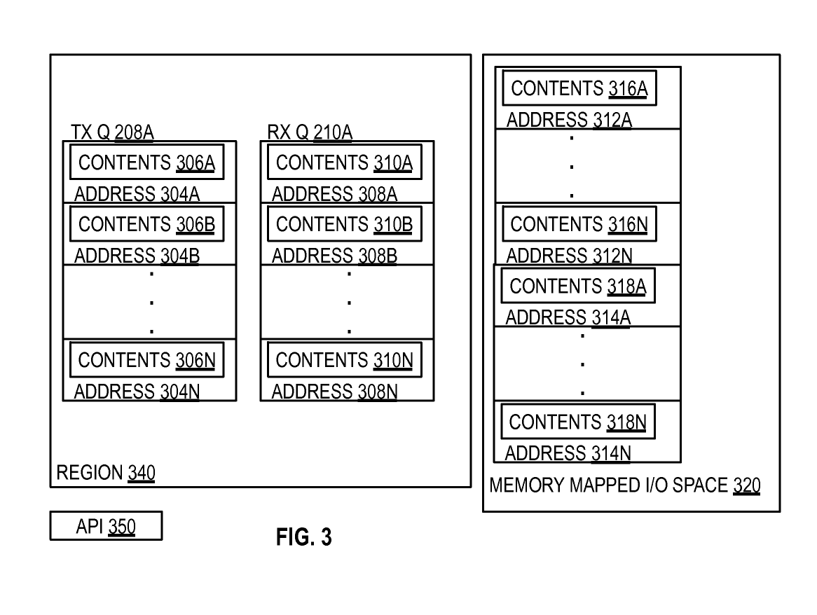

For example, as shown in FIG. 3, one or more transmit queues 208A may comprise one or more (and in this embodiment, a plurality of) addresses 304A . . . 304N. One or more receive queues 210A may comprise one or more (and in this embodiment, a plurality of) addresses 308A . . . 308N. Addresses 304A . . . 304N, addresses 308A . . . 308N, and queues 208A, 210A may be comprised and/or resident in, at least in part, one or more memory regions 340 that may be comprised and/or resident in, at least in part, one or more virtual machines 204A. During, for example, an initialization phase and/or process of the one or more VA 22A, virtual machines 204A, and/or applications 206A, one or more interface processes 42 may map, at least in part, one or more (and in this embodiment, multiple) addresses 304A . . . 304N; 308A . . . 308N of one or more (and in this embodiment, multiple) queues 208A, 210A to one or more (and in this embodiment, multiple) corresponding addresses 312A . . . 312N; 314A . . . 314N in one or more memory mapped I/O spaces 320. One or more memory mapped I/O spaces 320 may be associated with and/or comprised in, at least in part, one or more interfaces 44, interface processes 42, and/or virtual switch processes 38. After such initialization phase and/or process, one or more virtual switch processes 38 may capable of accessing, at least in part, the one or more addresses 304A . . . 304N; 308A . . . 308N of the one or more queues 208A, 210A by accessing, at least in part, the one or more corresponding addresses 312A . . . 312N; 314A . . . 314N in the one or more memory mapped I/O spaces 320.

For example, in this embodiment, one or more interfaces 44 and/or processes 42 may be or comprise one or more API 350 that may be called during, at least in part, such initialization phase and/or process, by one or more processes 23A, VA 22A, virtual machines 204A, and/or applications 206A. This may result, at least in part, in one or more processes 42 requesting that VMM 55 allocate, at least in part, one or more spaces 320 that may be and/or act as, at least in part, one or more memory mapped/backed files that may permit direct memory access (DMA) to queues 208A, 210A, and/or to the addresses 304A . . . 304N; 308A . . . 308N that may comprise queues 208A, 210A (e.g., by accessing corresponding addresses 312A . . . 312N; 314A . . . 314N in one or more spaces 320). In response, at least in part, to such request, VMM 55 may allocate and/or establish, at least in part, one or more spaces 320. Also in response, at least in part, to such request, VMM 55 may provide, at least in part, to one or more interface processes 42, the one or more addresses 304A . . . 304N; 308A . . . 308N of the one or more queues 208A, 210A, and/or the corresponding addresses 312A . . . 312N; 314A . . . 314N in the one or more spaces 320.

Additionally, during initialization phase of the one or more processes 42 and/or 38, one or more processes 42 and/or 38 may establish, at least in part, network data buffers and/or transmit/receive queues that may be used by the one or more processes 42 and/or 38 to buffer packets and/or data that are to be transmitted from, and/or have been received from the one or more physical devices 120A, and/or to carry out network operations/communication operations and/or services related to such transmission and/or reception of such packets and/or data. In this embodiment, such packets and/or data received from the one or more physical devices 120A may be destined for reception by the one or more VA 22A, virtual machines 204A, and/or applications 206A. Also, in this embodiment, such packets and/or data that are to be transmitted from the one or more physical devices 120A may have originated (e.g., as one or more sources) from the one or more VA 22A, virtual machines 204A, and/or applications 206A. Although not shown in the Figures, one or more processes 42 and/or 38 may comprise, establish and/or maintain, at least in part, one or more (e.g., physical interfaces) between themselves and the one or more physicals devices 120A to facilitate and/or permit the execution of these and/or other related operations. These one or more not shown physical interfaces of one or more processes 42 and/or 38 that may be involved in transmission to and/or from the one or more physical devices 120 may be serviced, at least in part, by one or more processes 42 and/or 38.

Based at least in part upon the addresses 304A . . . 304N; 308A . . . 308N; 312A . . . 312N; 314A . . . 314N provided by the VMM 55, one or more processes 42 may be capable of locating, and/or accessing the contents 306A . . . 306N; 310A . . . 310N of the addresses 304A . . . 304N; 308A . . . 308N, of the queues 208A, 210A, respectively in the one or more regions 340. Also, based at least in part upon the addresses 304A . . . 304N; 308A . . . 308N; 312A . . . 312N; 314A . . . 314N provided by the VMM 55, one or more interface processes 42 may be capable of mapping, at least in part, the respective addresses 304A . . . 304N; 308A . . . 308N of the queues 208A, 210A, and/or their respective contents 306A . . . 306N; 310A . . . 310N, to the corresponding respective addresses 312A . . . 312N; 314A . . . 314N and corresponding respective contents 316A . . . 316N; 318A . . . 318N in the one or more spaces 320. This may facilitate, at least in part, communication between the one or more physical devices 120A . . . 120N and one or more VA 22A via the one or more interfaces 44, in a manner that may be independent of, and/or bypass, at least in part, use and/or involvement of the one or more kernel processes 19 and/or operating system processes 31. Advantageously, this may obviate the need to copy and/or buffer packets and/or other data structures to and/or from kernel space 17 in order to carry out such communication. Also, advantageously, this may eliminate the need to perform context switching between kernel space 17 and one or more user spaces 15 in order to carry out such communication. Advantageously, in this embodiment, this may reduce or eliminate the latency and/or processing overhead.

More specifically, in this embodiment, the addresses 312A . . . 312N; 314A . . . 314N may be correlated with the addresses 304A . . . 304N; 308A . . . 308N, and also may be the respective transmit and receive queue addresses used by the one or more processes 42 and/or 38 to service the one or more physical devices 120A. For example, addresses 312A . . . 312N may serve as the transmit queue addresses used by the one or more processes 38 and/or 42 for servicing the one or more physical devices 120A, and also may correspond and/or be correlated to the transmit queue addresses 304A . . . 304N of the one or more VA 22A, virtual machines 204A, and/or applications 206A. Also, for example, addresses 314A . . . 314N may serve as the receive queue addresses used by the one or more processes 38 and/or 42 for servicing the one or more physical devices 120A, and also may correspond and/or be correlated to the receive queue addresses 308A . . . 308N of the one or more VA 22A, virtual machines 204A, and/or applications 206A.

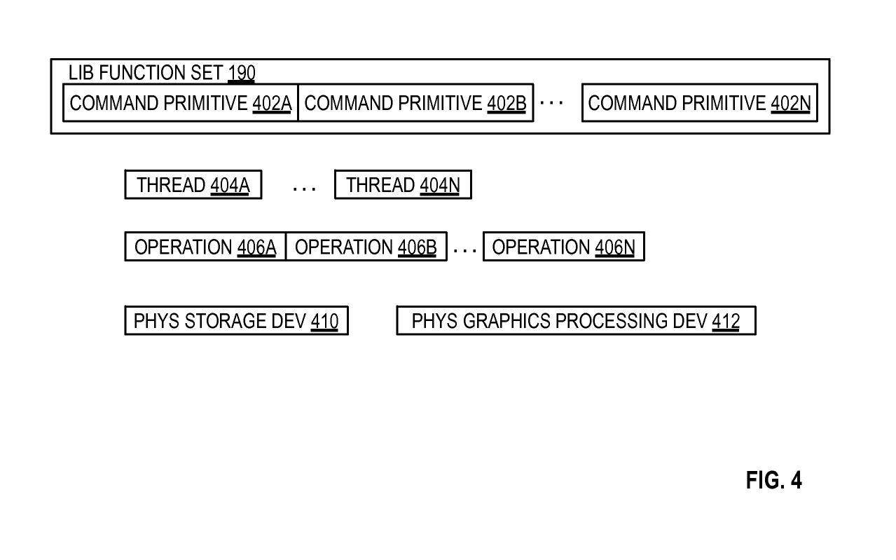

As stated above, one or more virtual data planes 150 may comprise one or more sets of library functions 190 and/or one or more virtual switch processes 38. As shown in FIG. 4, in this embodiment, one or more sets of library functions 190 may provide, at least in part, run time command primitives 402A . . . 402N. The command primitives 402A . . . 402N may be associated with and/or used to implement, at least in part, certain relatively basic and/or lower level operations that may be involved with, at least in part, communicating between the one or more physical devices 120A . . . 120N and one or more VA 22A via the one or more interfaces 44. Examples of such relatively basic and/or lower level operations may include network packet buffer management, network packet data copying, and/or queue access operations. For example, depending upon the particular implementation of this embodiment, one or more command primitives 402A may be or comprise, at least in part, one or more queue access command primitives that, when executed, may access one or more of the queues (e.g., 208A, 210A) and/or spaces 320, in a manner that may avoid or substantially reduce the risk of queue resource contention and/or data corruption. For example, such command primitives 402A may implement, when executed, one or more techniques intended to reduce or eliminate such resource contention and/or data corruption, at least in part. Such techniques may include use of one or more lockless queuing operations, one or more atomic reading/writing operations, and/or one or more single reader/single writer operations, directed to and/or involving, at least in part, one or more queues 208A, 210A and/or spaces 320. Of course, the above listing of such techniques is not exhaustive, and many alternatives are possible without departing from this embodiment.

In this embodiment, one or more virtual switch processes 38 may be implemented, at least in part, as multiple threads 404A . . . 404N (see FIG. 4) that may be executed, at least in part, by multiple processor cores 20A . . . 20N of one or more host processors 12. These threads 404A . . . 404N may implement, at least in part, the various operations (illustrated symbolically by blocks 406A . . . 406N in FIG. 4) that may be carried out by one or more processes 38. Such operations 406A . . . 406N may comprise, for example, interface instantiation operations 406A, interface de-instantiation operations 406B, and/or packet processing operations 406N. Such interface instantiation operations 406A and/or de-instantiation operations 406B may facilitate instantiation and/or de-instantiation of one or more interfaces 44 and/or other interfaces implemented by one or more virtual switch processes 38. The multiple threads 404A . . . 404N (and also, therefore, the multiple cores 20A . . . 20N executing them) may be capable of accessing, essentially contemporaneously, and substantially without resource contention-related problems (as a result, at least in part, of one or more interfaces 44 and/or library functions 190), multiple queues 208A . . . 208N; 210A . . . 210N of the multiple VA 22A . . . 22N and/or virtual machines 204A . . . 204N.

For purposes of illustration, in operation, in response, at least in part to reception, at least in part, of one or more packets by one or more physical devices 120A from one or more links 51A, one or more virtual switch processes 38 and/or interface processes 42 may directly write (with no intermediate copying) the one or more packets and/or related context information, as contents (e.g., 318A), into one or more appropriate addresses (e.g., 314A) in one or more spaces 320. One or more processes 38 and/or 42 may then directly write (with no intermediate copying), at least in part, the one or more packets (and related context information), as contents 310A, into one or more corresponding addresses 308A of one or more receive queues 210A for processing by the one or more applications 206A, processes 23A, virtual machines 204A, and/or VA 22A. Also, in operation, the writing, at least in part, by the one or more applications 206A, processes 23A, virtual machines 204A, and/or VA 22A of one or more packets (and related context information) into one or more addresses (e.g., 304A) of one or more transmit queues 208A (e.g., as contents 306A) may result in, at least in part, one or more processes 38 and/or 42 directly writing such contents 306A into one or more addresses 312A, as contents 316A thereof, for transmission by one or more physical devices 120A.

In this embodiment, in order to maintain compatibility with prior legacy (e.g., Linux kernel/operating system-call-based) implementations, from the vantage point of the VMM 55, one or more processes 23A, VA 22A, virtual machines 204A, physical devices 120A . . . 120N, and/or applications 206A, API 350 may be compatible, at least in part, with such prior legacy implementations. This may be accomplished, at least in part, in this embodiment, by constructing the one or more interfaces 44 and/or API 350 such that they may be compatible with legacy implementations that utilize Quick Emulator (“QEMU” available under the GNU General Public License of the GNU Project) “mem-path” and “mem-prealloc” functionality with Linux “hugetlbfs” to map VA address spaces, and/or character devices in user space technology to maintain compatibility with Linux kernel vhost-net implementations. Of course, this is merely exemplary, and many variations are possible without departing from this embodiment. Advantageously, in this embodiment, this may offload, at least in part, to the one or more interface processes 42, the processing that otherwise would be carried out in accordance in such legacy implementations by the kernel/operating system, while still maintaining, from the vantage point of the entities calling the API 350 and/or interface 44, compatibility with such legacy implementations. Further advantageously, this may permit modification and/or extension of the one or more interface processes 42 (e.g., to offer other and/or additional functionality) not to implicate the operating system's producer's proprietary rights. Further advantageously, in this embodiment, by integrating switching, fabric, queue/memory mapped I/O space mapping, and physical device driver functions into a single, integrated software entity (e.g., one or more virtual switches 38 having one or more interfaces 44), this may reduce or eliminate the amount of data/command copying and buffering, as well as, the associated processing overhead and/or latency, that may be involved in this embodiment. Indeed, it has been found that, in operation, a system made in accordance with this embodiment may exhibit an order of magnitude greater throughput and an order of magnitude less processing latency in processing worse-case-sized packets (e.g., of less than or equal to 128 bytes in size) than may be the case when such packets are processed by such legacy implementations.

In this embodiment, the network communications that may be carried out, at least in part, by physical network I/O devices 120A . . . 120N may comply and/or be compatible, at least in part, with one or more communication protocols. Additionally or alternatively, the related network control/monitoring operations that may be carried out, at least in part, by VA 22A . . . 22N, virtual machines 204A . . . 204N, applications 206A, processes 23A . . . 23N, one or more virtual data planes 150, one or more virtual switch processes 38, one or more sets of library functions 190, one or more interface processes 42, and/or one or more interfaces 44 may comply and/or be compatible with these one or more communication protocols. Examples of such protocols may include, but are not limited to, Ethernet and/or Transmission Control Protocol/Internet Protocol protocols. The one or more Ethernet protocols that may be utilized in this embodiment may comply or be compatible with, at least in part, IEEE 802.3-2008, Dec. 26, 2008. The one or more TCP/IP protocols that may be utilized in system 100 may comply or be compatible with, at least in part, the protocols described in Internet Engineering Task Force (IETF) Request For Comments (RFC) 791 and 793, published September 1981. Of course, many different, additional, and/or other protocols may be used without departing from this embodiment.

Also, in this embodiment, one or more virtual switch processes 38 may comply and/or be compatible with, at least in part, Open vSwitch Version 2.0.0, made available Oct. 15, 2013 (and/or other versions thereof), by the Open vSwitch Organization. Additionally or alternatively, one or more processes 38 may be compatible with, at least in part, other virtual switch software and/or protocols (e.g., as manufactured and/or specified by VMware, Inc., of Palo Alto, Calif., U.S.A., and/or others).

Many alternatives are possible without departing from this embodiment. For example, as shown in FIG. 4, one or more of the physical devices 120A . . . 120N may be or comprise, at least in part, one or more physical (e.g., disk, solid state, phase-change, and/or removable) storage devices 410 and/or one or more physical (e.g., three dimensional) graphics processing devices 412. Each of these devices 410 and/or 412 may be (e.g., physically, geographically, virtually, and/or logically) remote, at least in part, from the one or more hosts 10A, VA 22A, and/or virtual machines 204A. For example, one or more devices 410 and/or 412 may be comprised in, at least in part, one or more physical devices 120B and/or 120N in hosts 10B and/or 10N, respectively. Communication between one or more hosts 10A and one or more such remote devices 410 and/or 412 may be carried out, at least in part, via one or more networks 50 and/or one or more physical devices 120A. In accordance with the principles of this embodiment, such remote devices 410 and/or 412 may appear as one or more local devices 140 to the one or more VA 22A . . . 22N, when the one or more VA 22A . . . 22N communicates with the one or more remote devices 410 and/or 412 via the one or more interfaces 44 and/or processes 42.

In this embodiment, an address may be, comprise, and/or indicate, at least in part, one or more logical, virtual, and/or physical locations. Also, in this embodiment, accessing an entity may comprise one or more operations that may facilitate and/or result in, at least in part, the reading from and/or writing to the entity.

In this embodiment, a set of items joined by the term “and/or” may mean any subset of the set of items. For example, in this embodiment, the phrase “A, B, and/or C” may mean the subset A (taken singly), the subset B (taken singly), the subset C (taken singly), the subset A and B, the subset A and C, the subset B and C, or the subset A, B, and C. Analogously, in this embodiment, a set of items joined by the phrase “at least one of” may mean any subset of the set of items. For example, in this embodiment, the phrase “at least one of A, B, and/or C” may mean the subset A (taken singly), the subset B (taken singly), the subset C (taken singly), the subset A and B, the subset A and C, the subset B and C, or the subset A, B, and C.

Thus, in a first example in this embodiment, a virtualization-related apparatus may be provided. The apparatus may comprise circuitry to execute at least one interface process in at least one user space of a host. The host, in operation, may also have at least one kernel space. The at least one interface process may provide at least one interface, at least in part, between at least one virtual appliance and at least one virtual data plane. The at least one virtual data plane may facilitate, at least in part, communication between at least one physical device and at least one virtual appliance via the at least one interface. The at least one physical device may appear, when the at least one virtual appliance communicates with the at least one physical device via the at least one interface, as at least one local device. The at least one virtual appliance and the at least one interface may be resident in the at least one user space.

In a second example of this embodiment may comprise some or all of the elements of the first example, the virtual appliance may provide, at least in part, at least one virtual function. The at least one virtual function may be implemented, at least in part, by at least one virtual machine executing at least one application.

In a third example of this embodiment that may comprise some or all of the elements of the first or second examples, the at least one physical device may comprise at least one physical I/O device. The at least one virtual appliance may comprise at least one network communication process to maintain, at least in part, at least one network communication queue to facilitate, at least in part, the communication. The at least one virtual data plane may comprise at least one virtual switch process and at least one set of library functions. The at least one virtual switch process and the at least one set of library functions may be resident in the at least one user space. The at least one interface process may map, at least in part, at least one address in the at least one queue to at least one corresponding address in at least one memory mapped I/O space associated, at least in part, with the at least one interface. The at least one virtual switch process may access at least one address in the at least one queue in accordance with the at least one corresponding address in the at least one memory mapped I/O space.

In a fourth example of this embodiment that may comprise some or all of the elements of the third example, during initialization of the at least one virtual appliance, at least one application programming interface call may be made that may result, at least in part, in the at least one address in the at least one queue being provided to the at least one interface process. The at least one memory mapped I/O space may be allocated, at least in part, by at least one virtual machine monitor. The at least one memory mapped I/O space may correspond to at least one region of at least one virtual machine that comprises multiple addresses.

In a fifth example of this embodiment that may comprise some or all of the elements of the fourth example, the at least one interface process is to locate and access contents of the multiple addresses of the at least one region. The at least one interface process also may map the contents to corresponding addresses of the at least one memory mapped I/O space.

In a sixth example of this embodiment that may comprise some or all of the elements of any of the preceding examples, the at least one virtual data plane may comprise at least one set of library functions and at least one virtual switch process. The at least one set of library functions may provide, at least in part, command primitives associated with buffer management, data copying, and queue access. One or more queue access primitives, when executed, may implement, at least in part, one or more lockless queuing operations, one or more atomic reading/writing operations, and/or one or more single reader/single writer operations. The at least one virtual switch process may comprise multiple threads that may be executed by multiple processor cores. The multiple threads may implement, at least in part, interface instantiation, interface de-instantiation, and packet processing.

In a seventh example of this embodiment that may comprise some or all of the elements of any of the preceding examples, the apparatus may comprise the at least one physical device. The at least one physical device may comprise at least one physical disk device that may be remote, at least in part, from the host, and/or at least one physical graphics processing device that may be remote, at least in part, from the host.

In an eighth example of this embodiment, one or more computer-readable memories may be provided. The one or more computer-readable memories may store one or more instructions that when executed by a machine may result in the performance of operations that may comprise (1) the operations that may be performed by the apparatus in any of the apparatus' preceding examples, and/or (2) any combination of any of the operations performed by the apparatus in any of the apparatus' preceding examples.

In a ninth example of this embodiment, a virtualization-related method may be provided. The method may comprise (1) the operations that may be performed by the apparatus in any of the apparatus' preceding examples, (2) any combination of any of the operations performed by apparatus in any of the apparatus' preceding examples, and/or (3) any combination of any of the operations that may be performed by execution of the one or more instructions stored in the one or more computer-readable memories of the eighth example of this embodiment.

In a tenth example of this embodiment, means may be provided to carry out any of, and/or any combination of, the operations that may be performed by the method, apparatus, and/or one or more computer-readable memories in any of the preceding examples. In an eleventh example of this embodiment, machine-readable memory may be provided that may store instructions and/or design data, such as Hardware Description Language, that may define one or more subsets of the structures, circuitry, apparatuses, features, etc. described herein (e.g., in any of the preceding examples of this embodiment). Many alternatives, modifications, and/or variations are possible without departing from this embodiment.

What is claimed is:

1. A virtualization-related apparatus comprising:
circuitry to execute at least one interface process in at least one user space of a host, the host in operation also to have at least one kernel space, the at least one process to provide at least one interface, at least in part, between at least one virtual appliance and at least one virtual data plane, the at least one virtual data plane to facilitate, at least in part, communication between at least one physical device and the at least one virtual appliance via the at least one interface, the at least one physical device to appear, when the at least one virtual appliance communicates with the at least one physical device via the at least one interface, as at least one local device, the at least one virtual appliance and the at least one interface to be resident in the at least one user space.

2. The apparatus of claim 1, wherein:
the virtual appliance is to provide, at least in part, at least one virtual function;
the virtual appliance is to be implemented, at least in part, by at least one virtual machine executing at least one application.

3. The apparatus of claim 1, wherein:
the at least one physical device comprises at least one physical network input/output (I/O) device;
the at least one virtual appliance comprises at least one network communication process to maintain, at least in part, at least one network communication queue to facilitate, at least in part, the communication;
the at least one virtual data plane comprises at least one virtual switch process and at least one set of library functions;
the at least one virtual switch process and the at least one set of library functions are to be resident in the at least one user space;
the at least one interface process is to map, at least in part, at least one address in the at least one queue to at least one corresponding address in at least one memory mapped I/O space associated, at least in part, with the at least one interface; and
the at least one virtual switch process is to access the at least one address in the at least one queue in accordance with the at least one corresponding address in the at least one memory mapped I/O space.

4. The apparatus of claim 3, wherein:
during initialization of the at least one virtual appliance, at least one application programming interface call is made that results, at least in part, in the at least one address in the at least one queue being provided to the at least one interface process;
the at least one memory mapped I/O space is allocated, at least in part, by at least one virtual machine monitor; and
the at least one memory mapped I/O space corresponds to at least one region of at least one virtual machine that comprises multiple addresses.

5. The apparatus of claim 4, wherein:
the at least one interface process is to locate and access contents of the multiple addresses of the at least one region; and
the at least one interface process is also to map the contents to corresponding addresses of the at least one memory mapped I/O space.

6. The apparatus of claim 1, wherein:
the at least one virtual data plane comprises at least one set of library functions and at least one virtual switch process;
the at least one set of library functions is to provide, at least in part, command primitives associated with buffer management, data copying, and queue access;
one or more queue access command primitives, when executed, implement, at least in part, at least one of:
one or more lockless queuing operations;
one or more atomic reading/writing operations; and
one or more single reader/single writer operations;
the at least one virtual switch process comprises multiple threads that are to be executed by multiple processor cores; and
the multiple threads implement, at least in part, interface instantiation, interface de-instantiation, and packet processing.

7. The apparatus of claim 1, wherein:
the apparatus comprises the at least one physical device;
the at least one physical device comprises at least one of:
at least one physical disk storage device that is remote, at least in part, from the host; and
at least one physical graphics processing device that is remote, at least in part, from the host.

8. One or more computer-readable memories storing one or more instructions that when executed by a machine result in performance of operations comprising:
executing at least one interface process in at least one user space of a host, the host in operation also to have at least one kernel space, the at least one process to provide at least one interface, at least in part, between at least one virtual appliance and at least one virtual data plane, the at least one virtual data plane to facilitate, at least in part, communication between at least one physical device and the at least one virtual appliance via the at least one interface, the at least one physical device to appear, when the at least one virtual appliance communicates with the at least one physical device via the at least one interface, as at least one local device, the at least one virtual appliance and the at least one interface to be resident in the at least one user space.

9. The one or more memories of claim 8, wherein:
the virtual appliance is to provide, at least in part, at least one virtual function;
the virtual appliance is to be implemented, at least in part, by at least one virtual machine executing at least one application.

10. The one or more memories of claim 8, wherein:
the at least one physical device comprises at least one physical network input/output (I/O) device;
the at least one virtual appliance comprises at least one network communication process to maintain, at least in part, at least one network communication queue to facilitate, at least in part, the communication;
the at least one virtual data plane comprises at least one virtual switch process and at least one set of library functions;
the at least one virtual switch process and the at least one set of library functions are to be resident in the at least one user space;
the at least one interface process is to map, at least in part, at least one address in the at least one queue to at least one corresponding address in at least one memory mapped I/O space associated, at least in part, with the at least one interface; and
the at least one virtual switch process is to access the at least one address in the at least one queue in accordance with the at least one corresponding address in the at least one memory mapped I/O space.

11. The one or more memories of claim 10, wherein:
during initialization of the at least one virtual appliance, at least one application programming interface call is made that results, at least in part, in the at least one address in the at least one queue being provided to the at least one interface process;
the at least one memory mapped I/O space is allocated, at least in part, by at least one virtual machine monitor; and
the at least one memory mapped I/O space corresponds to at least one region of at least one virtual machine that comprises multiple addresses.

12. The one or more memories of claim 11, wherein:
the at least one interface process is to locate and access contents of the multiple addresses of the at least one region; and
the at least one interface process is also to map the contents to corresponding addresses of the at least one memory mapped I/O space.

13. The one or more memories of claim 8, wherein:
the at least one virtual data plane comprises at least one set of library functions and at least one virtual switch process;
the at least one set of library functions is to provide, at least in part, command primitives associated with buffer management, data copying, and queue access;
one or more queue access command primitives, when executed, implement, at least in part, at least one of:
one or more lockless queuing operations;
one or more atomic reading/writing operations; and
one or more single reader/single writer operations;
the at least one virtual switch process comprises multiple threads that are to be executed by multiple processor cores; and
the multiple threads implement, at least in part, interface instantiation, interface de-instantiation, and packet processing.

14. The one or more memories of claim 8, wherein:
the at least one physical device comprises at least one of:
at least one physical disk storage device that is remote, at least in part, from the host; and
at least one physical graphics processing device that is remote, at least in part, from the host.

15. A virtualization-related method comprising:
executing, by circuitry, at least one interface process in at least one user space of a host, the host in operation also to have at least one kernel space, the at least one process to provide at least one interface, at least in part, between at least one virtual appliance and at least one virtual data plane, the at least one virtual data plane to facilitate, at least in part, communication between at least one physical device and the at least one virtual appliance via the at least one interface, the at least one physical device to appear, when the at least one virtual appliance communicates with the at least one physical device via the at least one interface, as at least one local device, the at least one virtual appliance and the at least one interface to be resident in the at least one user space.

16. The method of claim 15, wherein:
the virtual appliance is to provide, at least in part, at least one virtual function;
the virtual appliance is to be implemented, at least in part, by at least one virtual machine executing at least one application.

17. The method of claim 15, wherein:
the at least one physical device comprises at least one physical network input/output (I/O) device;
the at least one virtual appliance comprises at least one network communication process to maintain, at least in part, at least one network communication queue to facilitate, at least in part, the communication;
the at least one virtual data plane comprises at least one virtual switch process and at least one set of library functions;
the at least one virtual switch process and the at least one set of library functions are to be resident in the at least one user space;
the at least one interface process is to map, at least in part, at least one address in the at least one queue to at least one corresponding address in at least one memory mapped I/O space associated, at least in part, with the at least one interface; and
the at least one virtual switch process is to access the at least one address in the at least one queue in accordance with the at least one corresponding address in the at least one memory mapped I/O space.

18. The method of claim 17, wherein:
during initialization of the at least one virtual appliance, at least one application programming interface call is made that results, at least in part, in the at least one address in the at least one queue being provided to the at least one interface process;
the at least one memory mapped I/O space is allocated, at least in part, by at least one virtual machine monitor; and
the at least one memory mapped I/O space corresponds to at least one region of at least one virtual machine that comprises multiple addresses.

19. The method of claim 18, wherein:
the at least one interface process is to locate and access contents of the multiple addresses of the at least one region; and
the at least one interface process is also to map the contents to corresponding addresses of the at least one memory mapped I/O space.

20. The method of claim 15, wherein:
the at least one virtual data plane comprises at least one set of library functions and at least one virtual switch process;
the at least one set of library functions is to provide, at least in part, command primitives associated with buffer management, data copying, and queue access;
one or more queue access command primitives, when executed, implement, at least in part, at least one of:
one or more lockless queuing operations;
one or more atomic reading/writing operations; and
one or more single reader/single writer operations;
the at least one virtual switch process comprises multiple threads that are to be executed by multiple processor cores; and
the multiple threads implement, at least in part, interface instantiation, interface de-instantiation, and packet processing.

21. The method of claim 15, wherein:
the at least one physical device comprises at least one of:
at least one physical disk storage device that is remote, at least in part, from the host; and
at least one physical graphics processing device that is remote, at least in part, from the host.

22. A virtualization-related apparatus comprising:
means for executing at least one interface process in at least one user space of a host, the host in operation also to have at least one kernel space, the at least one process to provide at least one interface, at least in part, between at least one virtual appliance and at least one virtual data plane, the at least one virtual data plane to facilitate, at least in part, communication between at least one physical device and the at least one virtual appliance via the at least one interface, the at least one physical device to appear, when the at least one virtual appliance communicates with the at least one physical device via the at least one interface, as at least one local device, the at least one virtual appliance and the at least one interface to be resident in the at least one user space.

23. The apparatus of claim 22, wherein:
the at least one virtual data plane comprises at least one set of library functions and at least one virtual switch process;
the at least one set of library functions is to provide, at least in part, command primitives associated with buffer management, data copying, and queue access;
one or more queue access command primitives, when executed, implement, at least in part, at least one of:
one or more lockless queuing operations;
one or more atomic reading/writing operations; and
one or more single reader/single writer operations;
the at least one virtual switch process comprises multiple threads that are to be executed by multiple processor cores; and
the multiple threads implement, at least in part, interface instantiation, interface de-instantiation, and packet processing.

24. The apparatus of claim 22, wherein:
the virtual appliance is to provide, at least in part, at least one virtual function;
the virtual appliance is to be implemented, at least in part, by at least one virtual machine executing at least one application.

25. The apparatus of claim 22, wherein:
the at least one physical device comprises at least one physical network input/output (I/O) device;
the at least one virtual appliance comprises at least one network communication process to maintain, at least in part, at least one network communication queue to facilitate, at least in part, the communication;
the at least one virtual data plane comprises at least one virtual switch process and at least one set of library functions;
the at least one virtual switch process and the at least one set of library functions are to be resident in the at least one user space;
the at least one interface process is to map, at least in part, at least one address in the at least one queue to at least one corresponding address in at least one memory mapped I/O space associated, at least in part, with the at least one interface; and
the at least one virtual switch process is to access the at least one address in the at least one queue in accordance with the at least one corresponding address in the at least one memory mapped I/O space.
